(19) United States
(12) Patent Application Publication
(10) Pub. No.: US 2019/0118899 A1
(43) Pub. Date: Apr. 25, 2019

(54) BRAKING SYSTEM FOR BICYCLES OR SIMILAR

(71) Applicant: Jon AGIRRE GARMENDIA, Lazkao, Gipuzkoa (ES)

(72) Inventor: Jon AGIRRE GARMENDIA, Lazkao, Gipuzkoa (ES)

(21) Appl. No.: 16/074,712

(22) PCT Filed: Jan. 13, 2017
(86) PCT No.: PCT/ES2017/070020

§ 371 Date: Nov. 8, 2018

(30) Foreign Application Priority Data
Feb. 3, 2016 (ES) P201630121

(51) Int. Cl. B62L 1/00; B60B 27/00; F16D 65/12

(52) U.S. Cl. CPC B62L 1/005; B62L 1/00; B60B 27/0052; B60B 2900/3312; B60B 2200/47; B60B 2900/1216; F16D 65/128

(57) ABSTRACT

The invention relates to a braking system for bicycles or similar, designed to be used on any type of bicycle, improving both braking and the aerodynamic performance of the corresponding bicycle, said system comprising a circular body or disc (1) formed exclusively by the area of the brake track, such that the centre of the disc (1) is completely hollow. According to the invention, the disc (1) is joined to a brake caliper (2) that is screwed to a body (3) designed as an extension of the fork (4) of the bicycle and solidly connected to same, said body housing therein sufficient cable for the activation of the braking system.

### OBJECT OF THE INVENTION

The object of the present specification is a braking system for bicycles or similar, said system having a series of advantages for the bicycle both in relation to aerodynamics and usage safety.

### BACKGROUND OF THE INVENTION

The centuries-long development of the mode of transporting goods and people has been in a permanent state of constant evolution. As a result, there are signs that circular mechanisms have existed since the year 3000 B.C. that have evolved over time until today. All this is intrinsically bound to the need to find elements that can decelerate these mechanisms in order to control them.

These mechanisms, known as brakes, come in many types and applications. The case at hand relates to brakes applied in lightweight vehicles driven by human force or motorised bicycles. It can be seen that the braking system of said vehicles (bicycles and motorised bicycles) is based on applying a force “by means of clamping” with a hard element (pad, rubber, brake lining, etc.) on a rim or on a disc on the outside with respect to the characteristic elements of the assembly of the wheel, with the friction of these two surfaces being what brakes the vehicle, thereby reducing its speed.

These braking systems have a series of drawbacks, for example, the braking system by clamping on the rim lacks the power of a disc braking system, so the reduction capability of the vehicle is quite inferior to that of one with a disc braking system. And vice versa, the disc braking system cannot be integrated in the wheel, so it is exposed in a position that is very dangerous for the driver of the vehicle, and for people circulating nearby, i.e., the “pack” in cycling jargon, basically for two reasons.

The first reason is the high temperature the disc reaches caused by friction in the braking phase, so any contact with the disc produces significant burns. The second reason is that said disc, which has a very small thickness, acts like a “blade” in the radial position, with the subsequent cuts and amputations of limbs of the driver of the vehicle or anyone around him or her occurring during uncontrolled falls onto said disc.

Another aspect to be taken into account concerning said systems is the current positioning of the disc and of the braking caliper assembly, which affect the aerodynamics and stability of the vehicle, where it is always an impediment for the energy efficiency of the drive element of the vehicle.

### DESCRIPTION OF THE INVENTION

The technical problem solved by the present invention is to achieve a braking system that can be applied to bicycles or similar that improves the results of the bicycle both in relation to aerodynamics and usage safety. To that end, the braking system for bicycles or similar, object of the present specification, comprises a disc formed exclusively by the area of the brake track, such that the centre of the disc is completely hollow. In said system, said disc is joined to a brake caliper that is screwed to a body designed as an extension of the fork of the bicycle and solidly connected to same, said body housing therein sufficient cable for the activation of the braking system.

As a result of its design as a circular body with a planar surface part and of being integrated on the shaft of the wheel, the braking system herein described could be used in conventional bicycles, road bikes, time trial bikes, triathlon bikes, mountain bikes, city bikes, and even children's bikes.

The fact that the circular body is inside the radial plane of the wheel means that the entire face of the wheel is in the same plane, so the “blade” effect is eliminated. Likewise, the fact that the circular body is inserted on the shaft of the wheel (and in the opposite direction with respect to the conventional braking systems) means that the spokes thereof protect it, so in the event of a fall said spokes will act as a barrier, preventing the rider from being hurt and offering enhanced safety.

Due to its integration, the body present between the fork and the wheel of the bicycle (current disc brakes) ceases to exist, so the negative effect of this body (greater drag) on the aerodynamics of the bicycle at hand is eliminated. This is extremely important in bicycles used in competition, as it would amount to better performance of the user during the race.

Likewise, as it has a smaller surface, the disc or circular body will have a smaller front area since the disc is integrated as part of the wheel. This means that in order to reach a given same speed, the user of the present system will have to make less of an effort to move the wheel compared to another user of a bicycle that does not include the system herein described.

The system herein proposed, and more specifically the disc or circular body that comprises it, is made up exclusively of a surface intended to serve as the area of the brake track, such that the centre of the disc is completely hollow. This entails the system having a lower weight, which will therefore have an effect on the weight of the bicycle, which is a huge advantage over rivals in the case of sporting events.

Finally, it must be taken into account that the braking discs are exposed to considerable stress during operation. In the case of the invention, the fact that the disc is screwed on at the outer perimeter of said disc means that it has a smaller cantilevered surface, which provides a more rigid disc that is less exposed to stress, which causes a more stable and higher quality braking compared with other systems present on the market.

Throughout the description and claims, the word “comprises” and variants thereof do not intend to exclude other technical features, additions, components, or steps. For those skilled in the art, other objects, advantages, and features of the invention will be inferred in part from the description and in part from putting the invention into practice. The following examples and drawings are provided by way of illustration, and do not intend to limit the present invention. Furthermore, the present invention covers all the possible combinations of particular and preferred embodiments herein indicated.

### BRIEF DESCRIPTION OF THE DRAWINGS

A series of drawings that help to better understand the invention and are expressly related to an embodiment of said invention presented as a non-limiting example thereof is very briefly described below.

FIG. 1 shows a view of the braking system for bicycles or similar, object of the present specification.

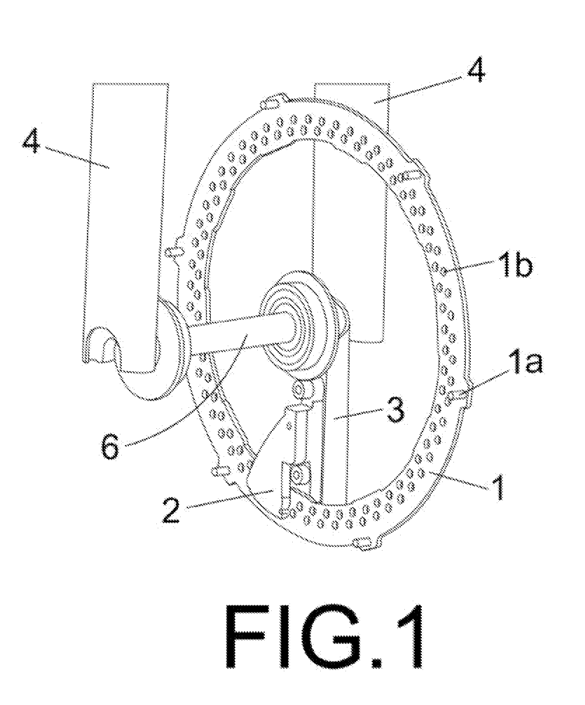

FIG. 2 shows a detailed view of the braking system for bicycles or similar, where the disc or circular body that is integrated and protected by the spokes of the wheel can be seen.

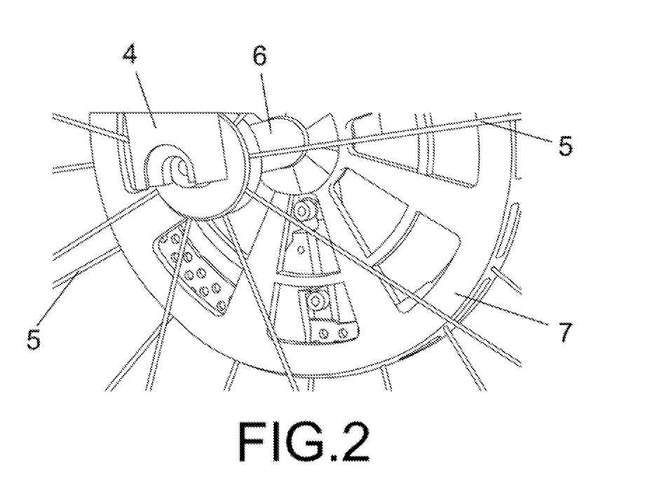

FIG. 3 shows a detailed view of the mode of joining the braking system for bicycles or similar to the fork of the bicycle.

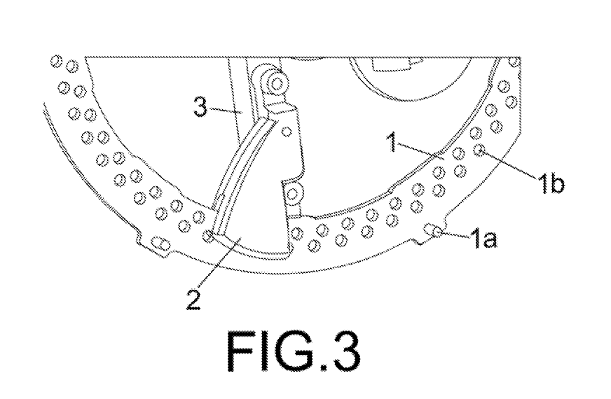

### PREFERRED EMBODIMENT OF THE INVENTION

The attached drawings show a preferred embodiment of the invention. More specifically, the braking system for bicycles or similar, object of the present specification, is characterised in that it comprises a circular body or disc (1) formed exclusively by the area of the brake track, such that the centre of the disc (1) is completely hollow. Furthermore, it has a plurality of holes (1b) designed for cooling the system.

Said disc (1) is joined to a brake caliper (2) that is screwed to a body (3) designed as an extension of the fork (4) of the bicycle and solidly connected to same on a single side of the mentioned fork (4).

The body (3) will house therein the cable required for the activation of the braking system.

Said disc (1) is inserted inside the radial plane of the wheel and is protected by the plane produced by the spokes (5) joining the rim to the shaft (6).

Finally, a surrounding body (7) joining the surface of the heads of the spokes (6) and the centre of the wheel (5) is positioned on said disc (1), whereby the rim securing mechanism is arranged on the face of the braking surface. The connection between the disc (1) and the surrounding body (7) is done as a result of the presence of small projections (1a) present on the disc which are housed in holes intended for that purpose arranged on the surrounding body (7).

1. Braking system for bicycles or similar, said system comprising a circular body or disc and being characterised in that:
said disc is formed exclusively by the area of the brake track, such that a center of the disc is completely hollow, and it has a plurality of holes on its surface that cool the system; the disc being screwed on at the outer perimeter thereof,
and wherein said disc is joined to a brake caliper that is screwed to a body designed as an extension of the fork of the bicycle and solidly connected to same on a single side of said fork,
and wherein said body houses therein the cable required for the activation of the braking system.

2. Braking system according to claim 1, wherein the disc is inserted inside the radial plane of the wheel and is protected by the plane produced by the spokes joining the rim to the shaft.

3. Braking system according to claim 1, wherein a surrounding body joining the surface of the heads of the spokes and the center of the wheel is positioned on said disc, whereby the rim securing mechanism is arranged on the face of the braking surface.

4. Braking system according to claim 2, wherein a surrounding body joining the surface of the heads of the spokes and the center of the wheel is positioned on said disc, whereby the rim securing mechanism is arranged on the face of the braking surface.
